(19) United States
(12) Patent Application Publication
(10) Pub. No.: US 2019/0031011 A1
(43) Pub. Date: Jan. 31, 2019

(54) POWERTRAIN MOUNT STRUCTURE OF VEHICLE

(71) Applicant: MAZDA MOTOR CORPORATION, Hiroshima (JP)

(72) Inventors: Tomo FUJIAKI, Hiroshima-city (JP); Tsuyoshi IWATA, Higashihiroshima-city (JP); Yosuke ARITA, Hatsukaichi-city (JP); Hiromi MIWADE, Hiroshima-city (JP)

(73) Assignee: MAZDA MOTOR CORPORATION, Hiroshima (JP)

(21) Appl. No.: 15/969,112

(22) Filed: May 2, 2018

(30) Foreign Application Priority Data
Jul. 26, 2017 (JP) 2017-144091

(51) Int. Cl. B60K 5/12; B60K 5/04; B62D 21/02; B62D 21/09; B62D 21/15; F16H 57/025

(52) U.S. Cl. CPC B60K 5/1283; B60K 5/04; B60K 5/1208; F16H 57/025; B62D 21/09; B62D 21/152; B62D 21/02

(57) ABSTRACT

A powertrain mount structure of a vehicle which comprises mount support portions to attach a powertrain to a pair of right-and-left front side frames, wherein the mount support portions include mount rubbers and mount brackets, respective longitudinal distances between plural attaching points of the right-and-left vehicle-body-side mount brackets are set to be longer than those of the right-and-left mount rubbers, and the mount rubbers are configured such that longitudinal positions thereof are changeable in a range between the plural attaching points of the mount brackets.

### BACKGROUND OF THE INVENTION

The present invention relates to a powertrain mount structure of a vehicle, which comprises a pair of right-and-left front side frames extending in a vehicle longitudinal direction on right-and-left both sides of an engine room and plural mounts (i.e., mount support portions) to attach a powertrain to the right-and-left front side frames.

In general, the powertrain comprises an engine and a transmission, and this powertrain is supported at the right-and-left front side frames, which a vehicle-body strength member, via the mount support portions. Further, each of these mount support portions comprises a mount rubber and a mount bracket. In a case where the resilient roll axis of the powertrain which is determined by a rigidity of the mount rubber and a mount supporting position does not match the principal axis of inertia which is determined by the mass distribution of the powertrain, rotational vibrations occur in accordance with the torque fluctuation of the engine and also linear vibrations of a vertical direction and a longitudinal direction occur in a linkage manner. Thereby, the acceleration and the shift shock of the vehicle are so increased that the ride comfort is deteriorated. Accordingly, it is preferable that the resilient roll axis of the powertrain be made to match the principal axis of inertia (the position of the gravity center of the powertrain) in order to prevent this deterioration.

In a case where a structure in which plural kinds of powertrain having different longitudinal positions of gravity center are selectively installed to the front side frames which are common vehicle bodies is adopted, since the gravity-center position differs according to the kind of powertrain, it may be considered that the position of the mount rubber of the mount support portion is configured to be changeable in order to cope with this difference of the gravity-center position.

Japanese Utility-Model Laid-Open Publication No. S61-75323 or Japanese Patent Laid-Open Publication No. 2004-155325 proposed a structure as the changeable structure of the mount-rubber position. The structure disclosed in the above-described first patent document is that a bracket attaching frame which is attached to an upper portion of a wheel apron and extends in a longitudinal direction and a front side frame which extends in the longitudinal direction have plural pairs of attaching holes which correspond to attachment portions of a vehicle-body-side mount bracket, and the resilient roll axis of a powertrain is made to match the gravity-center position of the powertrain by attaching the vehicle-body mount bracket to the best position which is selected according to the kind of the powertrain. In this conventional structure disclosed in the above-described first patent document, since the plural attaching holes are formed, the vehicle-body rigidity is decreased.

Meanwhile, the structure disclosed in the above-described second patent document is that a mount member to support a powertrain at a front side frame of a vehicle is provided, and this mount member is configured such that an arm provided at one end of a powertrain-side mount bracket is fixed to the powertrain, a shaft portion provided at the other end of the above-described bracket is arranged inside an outer tube, a mount rubber is provided between the shaft portion and the outer tube, a flat-plate shaped flange portion is fixed to the outer tube, this flange portion is attached to an inside face by a stud bolt penetrating a long hole of the flange portion and a nut, and the shaft portion, the outer tube and the most part of the mount rubber are arranged inside the front side frame, whereby the attaching position is configured to be changeable by using the above-described long hole. In this conventional structure disclosed in the above-described second patent document, there is a problem that the vehicle-body rigidity may be decreased because the long hole is formed.

### SUMMARY OF THE INVENTION

Accordingly, an object of the present invention is to provide a powertrain mount structure of a vehicle in which the position of the resilient roll axis of the powertrain is configured to be changeable without decreasing the vehicle-body rigidity.

The present invention is a powertrain mount structure of a vehicle comprising a pair of right-and-left front side frames extending in a vehicle longitudinal direction on right-and-left both sides of an engine room, a first mount including a first mount rubber and a first mount bracket which holds the first mount rubber and has plural attaching points to one of the front side frames which are spaced apart from each other in the vehicle longitudinal direction, the first mount being configured to attach the powertrain to the one of the front side frames with the first mount bracket via the first mount rubber, and a second mount including a second mount rubber and a second mount bracket which holds the second mount rubber and has plural attaching points to the other of the front side frames which are spaced apart from each other in the vehicle longitudinal direction, the second mount being configured to attach the powertrain to the other of the front side frames with the second mount bracket via the second mount rubber, characterized in that each of the first and second mount brackets is configured such that a longitudinal distance between the plural attaching points to the front side frame is longer than a longitudinal length of the mount rubber, and each of the first and second mount rubbers is configured such that a longitudinal position thereof is changeable in a range between the plural attaching points of each of the first and second mount brackets.

According to the present invention, since the mount brackets in which each longitudinal distance between the attaching points thereof is longer than the longitudinal length of each of the mount rubbers are provided and the longitudinal position of each of these mount rubbers is changeable in a range between the attaching points of each of these mount brackets, the position of the resilient roll axis of the powertrain is configured to be changeable without decreasing the vehicle-body rigidity (the rigidity of the front side frame).

In an embodiment of the present invention, the vehicle is configured to selectively install plural kinds of powertrain having different longitudinal positions of gravity center to a common vehicle body, the above-described first and second mounts comprise plural kinds of mount which have the same longitudinal distance between the plural attaching points of the mount brackets and different longitudinal positions of the mount rubbers, and the above-described configuration of the longitudinal position of the mount rubbers is achieved by selecting one of the above-described plural kinds of mount in accordance with the kind of powertrain selectively installed.

According to this embodiment, since the longitudinal position of each of the mount rubbers can be changed by exchanging the right-and-left mount brackets in a case where the longitudinal position of the gravity center of the powertrain selectively installed to the common vehicle body differs, the position of the resilient roll axis of the powertrain relative to the position of the gravity center of the powertrain can be made changeable. In particular, since the longitudinal position of each of the right-and-left mount rubbers is made changeable by the right-and-left mount brackets, it can be prevented that the resilient roll axis of the powertrain is configured to slant in a vehicle plan view.

Herein, the achieving of the changeable configuration of the longitudinal position of the mount rubbers by selecting one of the plural kinds of mount in accordance with the kind of powertrain selectively installed is configured such that in a case where the powertrain having a relatively forward-positioned gravity center is installed, the mount having a relatively forward-positioned mount rubber is selected.

In another embodiment of the present invention, the powertrain comprises an engine and a transmission which are arranged in a vehicle width direction, the above-described first and second mounts are configured such that one of the first and second mounts attaches the powertrain to the front side frame located on a transmission side and the other of the first and second mounts attaches the powertrain to the front side frame located on an engine side, each of the front side frames is configured to break at a frame breaking point in a vehicle frontal collision, the above-descried respective frame breaking points are configured such that the frame breaking point of the front side frame located on the transmission side is positioned in front of the mount bracket of the above-described one of the first and second mounts and the frame breaking point of the front side frame located on the engine side is positioned between the attaching points of the mount bracket of the above-described other of the first and second mounts, a rigidity of the mount bracket of the above-described other of the first and second mounts is set to be lower than that of the mount bracket of the above-described one of the first and second mounts such that the mount bracket of the other of the first and second mounts is made to break by a frame-breaking load which is generated in the vehicle frontal collision, and the longitudinal distance between the plural attaching points of the mount bracket of the above-described other of the first and second mounts is set to be longer than that between the plural attaching points of the mount bracket of the above-described one of the first and second mounts.

According to this embodiment, since the mount bracket fixed to the front side frame located on the engine side, which generally receives a relatively-low vibration-input load, is made to break in accordance with the front side frame's breaking at the breaking point of the front side frame located on the engine side in the vehicle frontal collision and the longitudinal distance between the attaching points of the mount bracket fixed to the front side frame located on the engine side is set to be longer than that between the attaching points of the vehicle-body-side mount bracket fixed to the front side frame located on the transmission side, the degree of position changeability of the mount rubbers can be increased, without damaging the performance of absorbing front-collision energy which can be attained by the front side frame's breaking at the breaking point of the front side frame located on the engine side in the vehicle frontal collision.

In another embodiment of the present invention, the mount bracket of the above-described one of the first and second mounts is made of a sheet metal member, and the mount bracket of the above-described other of the first and second mounts is made of a die-cast member.

According to this embodiment, the transmission-side mount (i.e., the above-described one of the first and second mounts) can bear a large load by means of the sheet-metal-made mount bracket. Meanwhile, the engine-side mount (i.e., the other of the first and second mounts) can bear a small load in a normal state and also breaking of the front side frame can be secured when the frame-breaking load is inputted in the vehicle frontal collision by means of the die-cast-made mount bracket.

In another embodiment of the present invention, reinforcing members are respectively provided inside the front side frames at positions between the plural attaching points of the vehicle-body-side mount brackets, and a non-reinforcing-member arrangement portion where no reinforcing member is arranged is provided at a specified position which corresponds to the frame breaking point of the front side frame located on the engine side which is located between the plural attaching points of the vehicle-body-side mount bracket.

According to this embodiment, since the non-reinforcing-member arrangement portion where no reinforcing member is arranged is provided at the specified position located between the attaching points of the vehicle-body-side mount bracket, it can be properly prevented that breaking of the front side frame at the position located between the attaching points of the mount bracket in the vehicle frontal collision is blocked.

Other features, aspects, and advantages of the present invention will become apparent from the following description which refers to the accompanying drawings.

### BRIEF DESCRIPTION OF THE DRAWINGS

FIG. 1 is a plan view showing a powertrain mount structure of a vehicle of the present invention.

FIG. 2 is a plan view showing a state where a longitudinal position of a mount rubber is changed rearward.

FIG. 3 is a side view showing an inside structure of a right-side front side frame.

FIG. 4 is a perspective view of FIG. 3.

FIG. 5 is a side view showing an inside structure of a left-side front side frame.

FIG. 6 is a perspective view of FIG. 5.

FIG. 7 is a perspective view showing a structure of a right-side powertrain mount of FIG. 1.

FIG. 8 is a perspective view showing a structure of a right-side powertrain mount of FIG. 2.

FIG. 9A is a major-part vertical sectional view of the structure of the powertrain mount of FIG. 7, and FIG. 9B is a major-part vertical sectional view of the structure of the powertrain mount of FIG. 8.

FIG. 10 is a perspective view showing a structure of a left-side powertrain mount of FIG. 1.

FIG. 11 is a perspective view showing a structure of a left-side powertrain mount of FIG. 1.

FIG. 12A is a major-part vertical sectional view of the structure of the powertrain mount of FIG. 10, and FIG. 12B is a major-part vertical sectional view of the structure of the powertrain mount of FIG. 11.

FIG. 13 is a perspective view showing a mount support portion shown in FIG. 7, when viewed from a forward-and-outward side of a vehicle.

FIG. 14 is a sectional view taken along line E-E of FIG. 13.

FIG. 15A is a plan view showing a changing state of a longitudinal position of a right-side mount rubber, and FIG. 15B is a plan view showing a changing state of a longitudinal position of a left-side mount rubber.

### DETAILED DESCRIPTION OF THE INVENTION

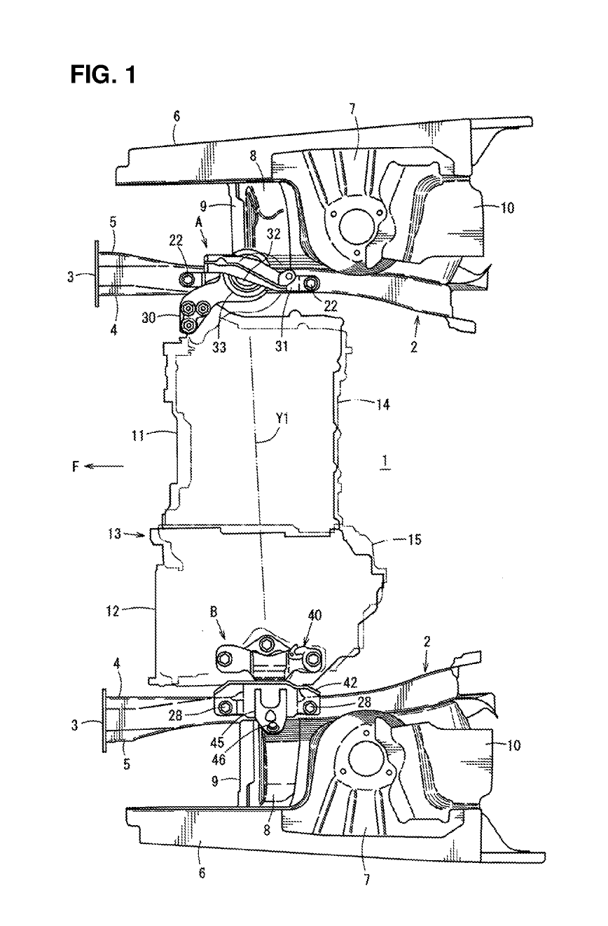

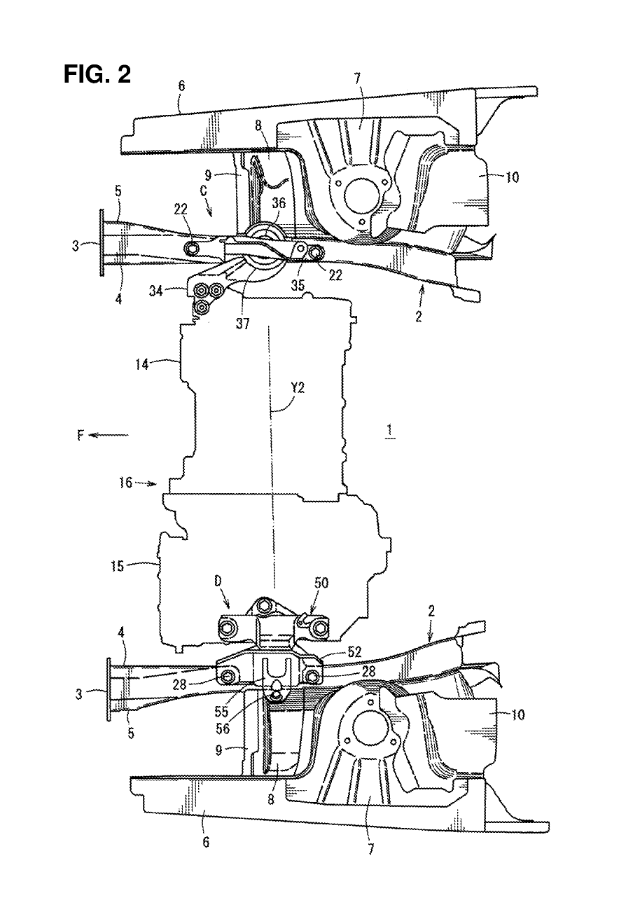

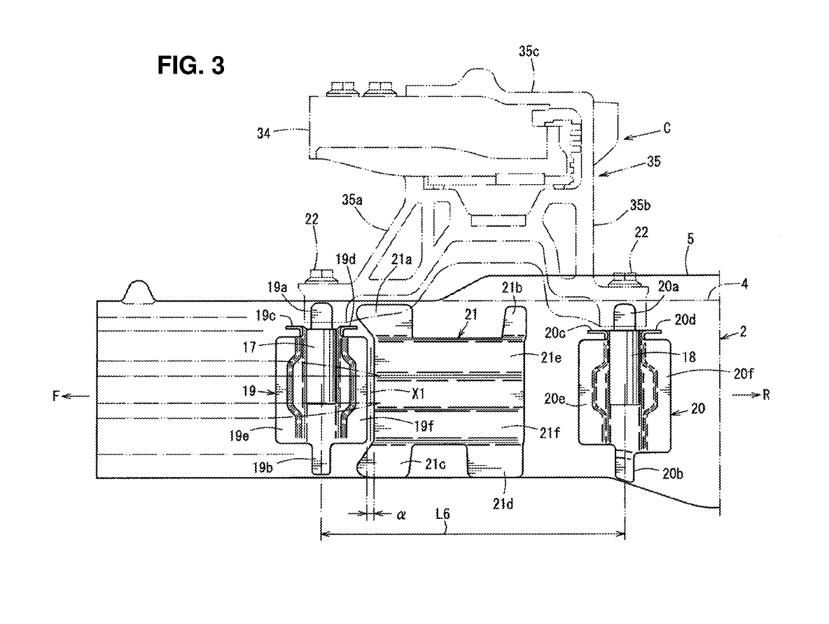

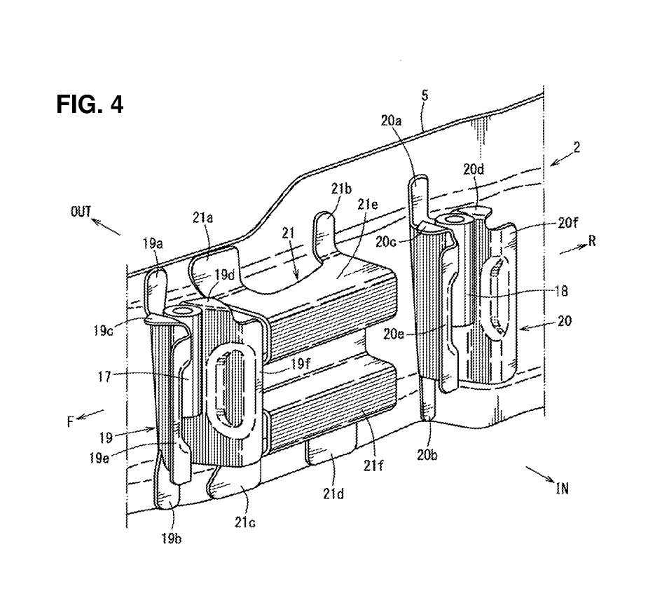

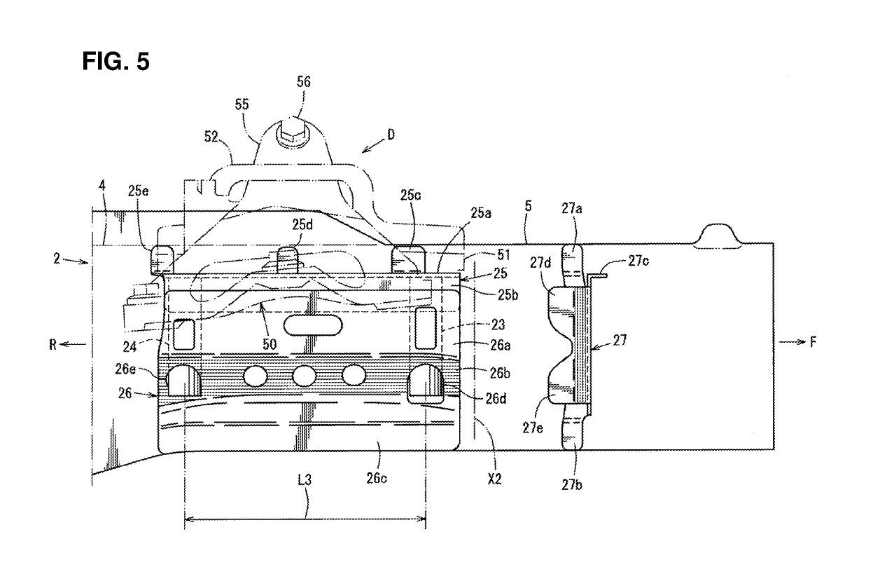

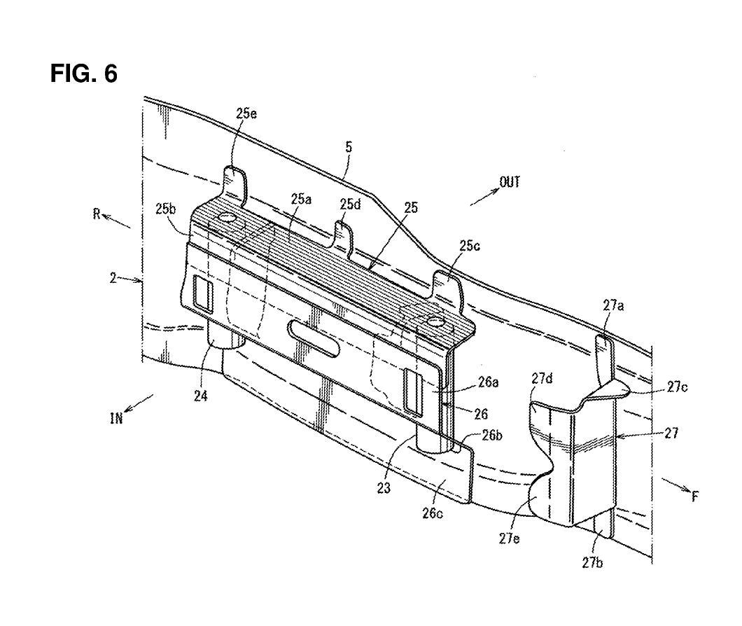

Hereafter, an embodiment of the present invention will be described referring to the drawings. The drawings show a powertrain mount structure of a vehicle, and FIG. 1 is a plan view showing the powertrain mount structure, FIG. 2 is a plan view showing a state where a longitudinal position of a mount rubber is rearward changed, FIG. 3 is a side view showing an inside structure of a right-side front side frame, FIG. 4 is a perspective view of FIG. 3, FIG. 5 is a side view showing an inside structure of a left-side front side frame, and FIG. 6 is a perspective view of FIG. 5.

A body-side structure will be described first before describing the powertrain mount structure. As shown in FIGS. 1 and 2, a pair of right-and-left front side frames 2, 2 which extend in a vehicle longitudinal direction at right-and-left both sides of an engine room 1 are provided, and a set plate 3 for attaching a crash can is attached to each front end of the front side frames 2, 2. The above-described front side frame 2 is a vehicle-body strength member which comprises a front side frame inner 4 and a front side frame outer 5 which are fixedly joined together so as to have a closed cross section extending in the vehicle longitudinal direction.

An apron 6 which extends forward from a hinge pillar is provided on an outward-and-upward side of the above-described front side frame 2, a suspension tower portion 7 is provided between the apron 6 and the front side frame 2, a wheel apron 8 which connects the apron 6 and the front side frame 2 is attached to a portion located right in front of the suspension tower portion 7, and a connecting member 9 which connects the apron 6 and the front side frame 2 is provided in front of the wheel apron 8. Further, a cowl side member 10 is provided at a rear portion of the suspension tower portion 7.

The present embodiment exemplifies, as plural kinds of powertrain provided in the engine room 1, a powertrain 13 which comprises an engine 11 and a transmission 12 which are connected together and is laterally arranged as shown in FIG. 1 and a powertrain 16 which comprises an engine 14 and a transmission 15 which are connected together and is laterally arranged as shown in FIG. 2.

As shown in FIGS. 3 and 4, inside the right-side front side frame 2 are provided a pair of front-and-rear cylindrical-shaped nut members 17, 18 which are spaced apart from each other in the longitudinal direction, a retainer 19 which fixedly supports the front-side nut member 17, a retainer 20 which fixedly supports the rear-side nut member 18, and a gusset 21 which is a reinforcing member arranged between the front-and-rear retainers 19, 20.

The front-side retainer 19 comprises a flange 19a which is fixed by respective upper-side joint flange portions of the front side frame inner 4 and the front side frame outer 5 (specifically, three-sheet welding fixation), a flange 19b which is fixed by respective lower-side joint flange portions of the front side frame inner 4 and the front side frame outer 5 (specifically, three-sheet welding fixation), and plural flanges 19c, 19d, 19e, 19f which are fixed to an inner face of the front side frame inner 4, and fixes the nut member 17 extending in the vertical direction at a U-shaped portion, in the plan view, which is formed between the front-and-rear flanges 19e, 19f.

Similarly to the front-side retainer 19, the rear-side retainer 20 comprises a flange 20a which is fixed by respective upper-side joint flange portions of the front side frame inner 4 and the front side frame outer 5 (specifically, three-sheet welding fixation), a flange 20b which is fixed by respective lower-side joint flange portions of the front side frame inner 4 and the front side frame outer 5 (specifically, three-sheet welding fixation), and plural flanges 20c, 20d, 20e, 20f which are fixed to the inner face of the front side frame inner 4, and fixes the nut member 18 extending in the vertical direction at a U-shaped portion, in the plan view, which is formed between the front-and-rear flanges 20e, 20f.

The gusset 21 comprises a pair of front-and-rear flanges 21a, 21b which are fixed by the upper-side flange portions of the front side frame 2 (three-sheet welding fixation), a pair of front-and-rear flanges 21c, 21d which are fixed by the lower-side flange portions of the front side frame 2 (three-sheet welding fixation), and two extensive protrusion portions 21e, 21f which extend in the vehicle longitudinal direction and protrude inward in a vehicle width direction in a U shape, in an elevational view of the vehicle, between the upper-side flanges 21a, 21b and the lower-side flanges 21c, 21d. The above-described nut members 17, 18 are the members into which bolts 22, 22 for vehicle-body-side mount bracket fastening (see FIG. 3) are screwed at engine-side mount support portions A, C, which will be described later.

As shown in FIGS. 5 and 6, inside the left-side front side frame 2 are provided a pair of front-and-rear cylindrical nut members 23, 24 which are spaced apart from each other in the longitudinal direction, gussets 25, 26 which are configured to be split into two pieces in the vertical direction as a reinforcing member to support the nut members 23, 24 and also reinforce the front side frame 2, and a brace member 27 which is arranged in front of the gussets 25, 26.

The upper-side gusset 25 comprises an upper piece 25a which extends in the longitudinal direction, a lower piece 25b which extends downward from an inward end, in the vehicle width direction, of the upper piece 25a, and plural flanges 25c, 25d, 25e which are fixed by the respective upper-side joint flange portions of the front side frame inner 4 and the front side frame outer 5 (three-sheet welding fixation).

The lower-side gusset 26 comprises an upper piece 26a which extends in the longitudinal direction and fixed to the lower piece 25b of the upper-side gusset 25, a slant piece 26b which extends outward and downward from a lower end of the upper piece 26a, a lower piece 26c which extends downward from a lower end of the slant piece 26b and fixed by the respective lower-side joint flange portions of the front side frame inner 4 and the front side frame outer 5 (three-sheet welding fixation), and nut-member holding holes 26d, 26e (see FIG. 5) which are formed at the slant piece 26b at locations which correspond to the nut members 23, 24, and this lower-side gusset 26 holds the nut members 23, 24 extending in the vertical direction at hole edges of the nut-member holding holes 26d, 26e.

The brace member 27 comprises a flange 27a which is fixed by the upper-side flange portions of the front side frame 2 (three-sheet welding fixation), a flange 27b which is fixed by the lower-side flange portions of the front side frame 2 (three-sheet welding fixation), and plural flanges 27c, 27d, 27e which are fixed to the inner face of the front side frame inner 4. The above-described nut members 23, 24 are the members into which bolts 28, 28 for vehicle-body-side mount bracket fastening (see FIGS. 1 and 2) are screwed at transmission-side mount support portions B, D, which will be described later.

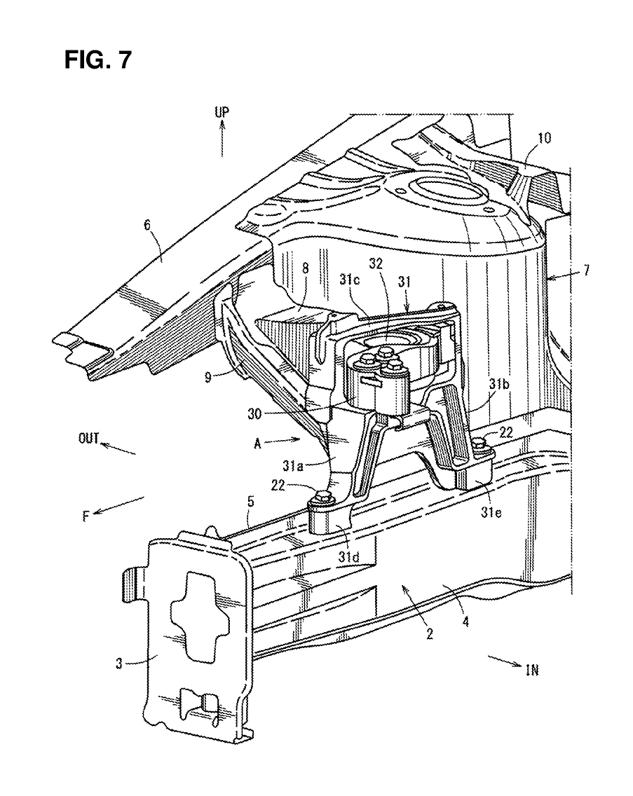

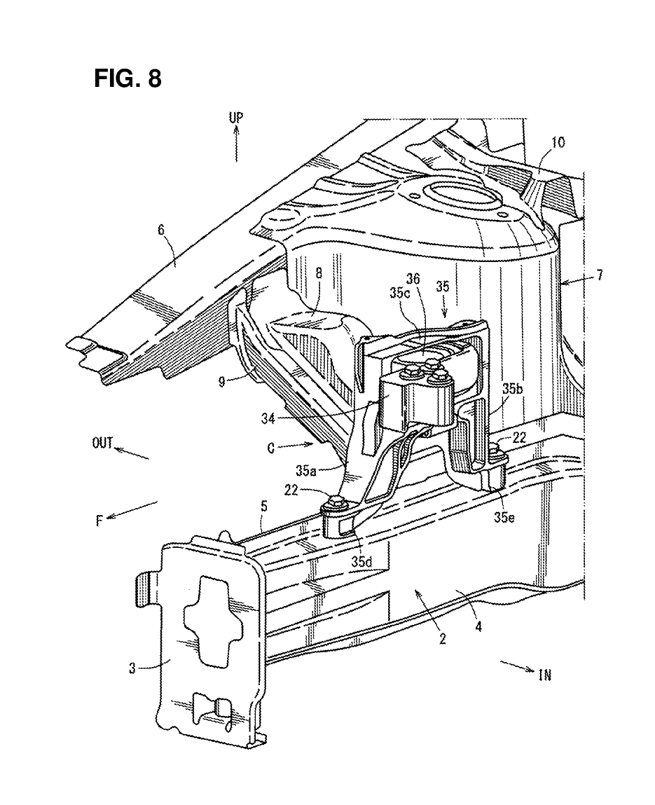

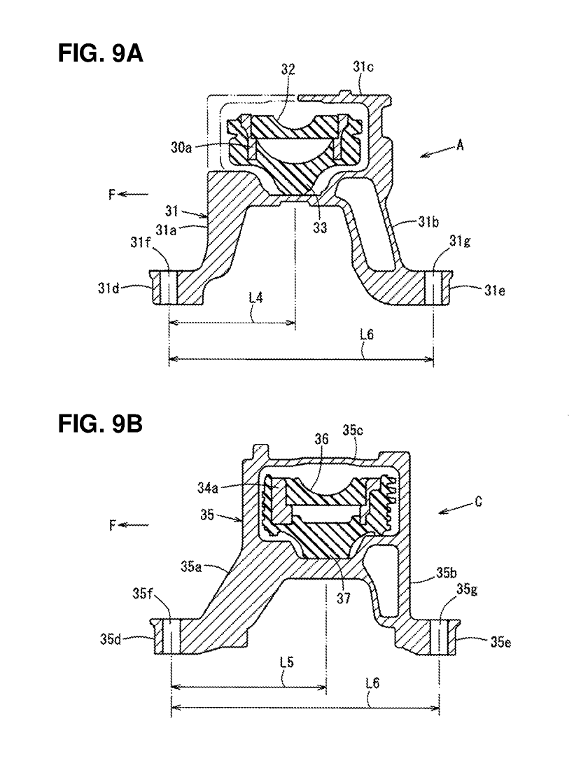

FIG. 7 is a perspective view showing a structure of a right-side powertrain mount of FIG. 1, FIG. 8 is a perspective view showing a structure of a right-side powertrain mount of FIG. 2, FIG. 9A is a major-part vertical sectional view of the structure of the powertrain mount of FIG. 7, and FIG. 9B is a major-part vertical sectional view of the structure of the powertrain mount of FIG. 8. The present embodiment is configured such that plural kinds of powertrain, i.e., the powertrain 13 and the powertrain 16 which have different longitudinal positions of gravity center, are selectively installed to the common vehicle body. In the present embodiment, the powertrain 13 and the powertrain 16 are configured such that the gravity center of the powertrain 13 is positioned in front of that of the powertrain 16 in the vehicle longitudinal direction.

That is, in a case where the powertrain 13 shown in FIG. 1 is installed, the powertrain 13 is supported at the front side frames 2, 2 by the engine-side mount support portion A and the transmission-side mount support portion B. In a case where the powertrain 16 shown in FIG. 2 is installed, the powertrain 16 is supported at the front side frames 2, 2 by the engine-side mount support portion C and the transmission-side mount support portion D.

As shown in FIGS. 1, 7 and 9A, the engine-side mount support portion A for the powertrain 13 comprises an engine-side mount bracket 30, a vehicle-body-side mount bracket 31, and mount rubbers 32, 33.

The vehicle-body-side mount bracket 31 comprises, as shown in FIG. 9A, front-and-rear leg portions 31a, 31b, a frame-shaped portion 31c which is integrally formed at upper portions of the front-and-rear leg portions 31a, 31b, attaching seats 31d, 31e which extend in the longitudinal direction from lower ends of the front-and-rear leg portions 31a, 31b, and attaching holes 31f, 31g for the bolts 22 which are formed at the attaching seats 31d, 31e.

The engine-side mount bracket 30 includes an inner tube 30a which is positioned inside the frame-shaped portion 31c, a mount rubber 32 is provided at an inner periphery of an upper side of the inner tube 30a, and the above-described mount rubber 33 is provided at an outer peripheral portion and a lower portion of the inner tube 30a.

Herein, a longitudinal distance L6 between respective axial center portions of the front-and-rear attaching holes 31f, 31g is set to be the same as (equal to) a longitudinal center L6 between respective axial center portions of the nut members 17, 18 shown in FIGS. 3 and 4, and a distance between the axial center portion of the front-side attaching hole 31f and a center portion, in the longitudinal direction, of the mount rubbers 32, 33 is set as L4. Further, the longitudinal distance L6 between the front-and-rear attaching points of the vehicle-body-side mount bracket 31 is set to be longer than the longitudinal length of the mount rubber 33.

As shown in FIGS. 2, 8 and 9B, the engine-side mount support portion C for the powertrain 16 comprises an engine-side mount bracket 34, a vehicle-body-side mount bracket 35, and mount rubbers 36, 37.

The vehicle-body-side mount bracket 35 comprises, as shown in FIG. 9B, front-and-rear leg portions 35a, 35b, a frame-shaped portion 35c which is interlay formed at upper portions of the front-and-rear leg portions 35a, 35b, attaching seats 35d, 35e which extend in the longitudinal direction from lower ends of the front-and-rear leg portions 35a, 35b, and attaching holes 35f, 35g for the bolts 22 which are formed at the attaching seats 35d, 35e.

The engine-side mount bracket 34 includes an inner tube 34a which is positioned inside the frame-shaped portion 35c, a mount rubber 36 is provided at an inner periphery of an upper side of the inner tube 34a, and the above-described mount rubber 37 is provided at an outer peripheral portion and a lower portion of the inner tube 34a.

Herein, a longitudinal distance L6 between respective axial center portions of the front-and-rear attaching holes 35f, 35g is set to be the same as (equal to) the longitudinal center L6 between the respective axial center portions of the nut members 17, 18 shown in FIGS. 3 and 4, and a distance between the axial center portion of the front-side attaching hole 35f and a center portion, in the longitudinal direction, of the mount rubbers 36, 37 is set as L5. Further, the longitudinal distance L5 shown in FIG. 9B is set to be longer than the longitudinal length L4 shown in FIG. 9A. That is, a relational expression L5>L4 is established.

Further, the longitudinal distance L6 which is the distance of the front-and-rear attaching points is set to be longer than the longitudinal length of the mount rubber 37, and the longitudinal positions of the mount rubbers 32, 33, 36, 37 are configured to be changeable in a range between the longitudinal distance L6, i.e., at a position shown in FIG. 9A and a position shown in FIG. 9B. That is, the mount rubbers 32, 33, 36, 37 which are held by the vehicle-body-side mount brackets 31, 35 are configured such that the longitudinal length thereof is changeable by exchanging the vehicle-body-side mount brackets 31, 35 for each of the powertrains 13, 16.

The vehicle-body-side mount brackets 31, 35 shown in FIGS. 9A and 9B are respectively fixed to an upper face portion of the front side frame inner 4 by using a pair of front-and-rear bolts 22 and nuts 17, 18.

As shown in FIG. 3, each of the front side frames 2 is configured to break at a frame breaking point X1 in a vehicle frontal collision, and the frame breaking point X1 of the engine-side front side frame shown in the same figure is positioned between the nut members 17, 18 as the front-and-rear attaching points of the mount support portions A, C (the vehicle-body-side mount brackets 31, 35).

Specifically, as shown in FIG. 3, the gusset 21 as the reinforcing member is provided within a range of the longitudinal distance L6 which is the distance between the front-and-rear attaching points of the vehicle-body-side mount brackets 31, 35 inside the front side frame 2. Within this rage of the longitudinal distance L6 of the engine-side front side frame 2 is provided a non-reinforcing-member arrangement portion a where no reinforcing member is arranged between a rear end of the retainer 19 and a front end of the gusset 21. Herein, this non-reinforcing-member arrangement portion a is set (positioned) at the above-described frame breaking point X1.

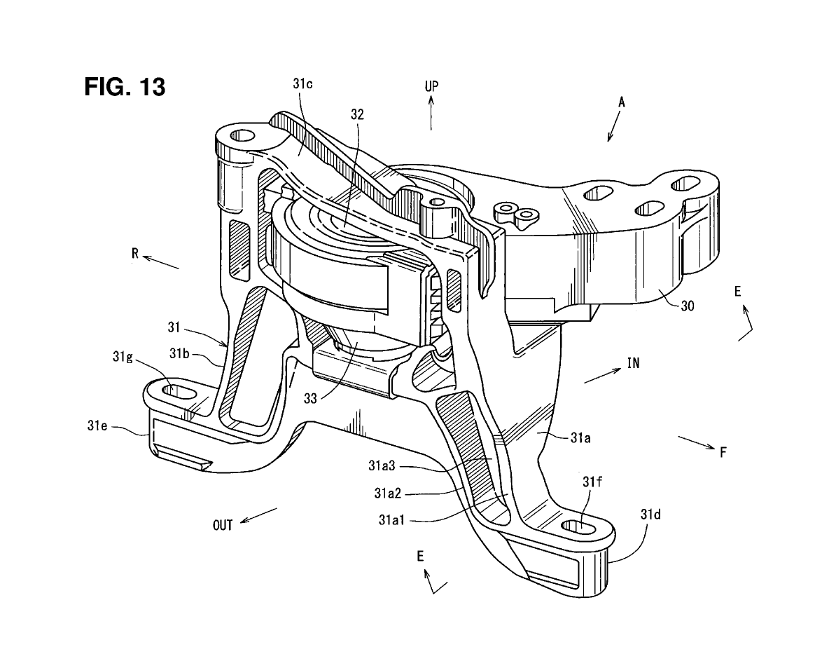

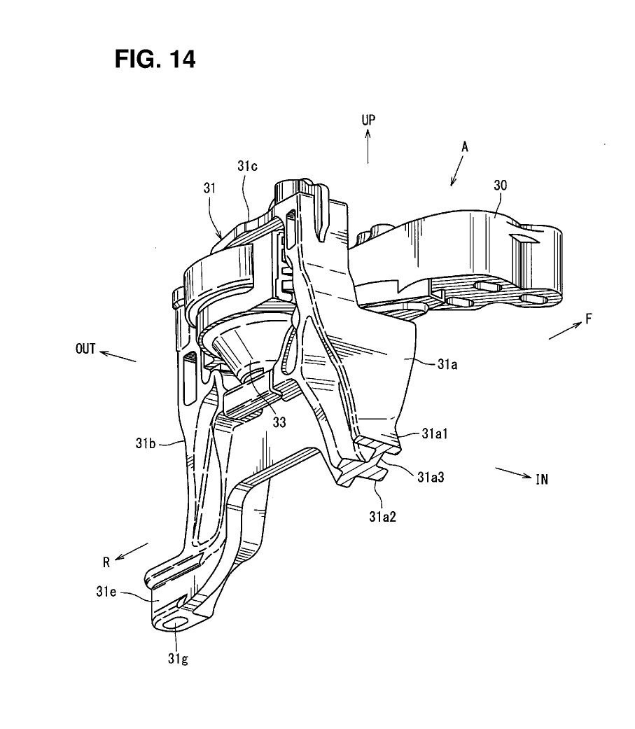

FIG. 13 is a perspective view showing the mount support portion A shown in FIG. 7, when viewed from a forward-and-outward side of the vehicle, and FIG. 14 is a sectional view taken along line E-E of FIG. 13.

As shown in FIG. 14, the front-side leg portion 31a of the vehicle-body-side mount bracket 31 is configured such that wide portions 31a1, 31a2 where the width, in the vehicle width direction, thereof is wide are interconnected by a narrow portion 31a3 where the width, in the vehicle width direction, thereof is narrow, and this narrow portion 31a3 substantially corresponds to the position of the non-reinforcing-member arrangement portion a shown in FIG. 3 (i.e., the frame breaking point X1), so that the front side frame 2 is configured to be made to break at this point by a frame-breaking load which is generated in the vehicle frontal collision.

The vehicle-body-side mount brackets 31, 35 fixed to the engine-side front side frame 2 are made of a die-cast member, respectively. Specifically, these are made of an aluminum die-cast member.

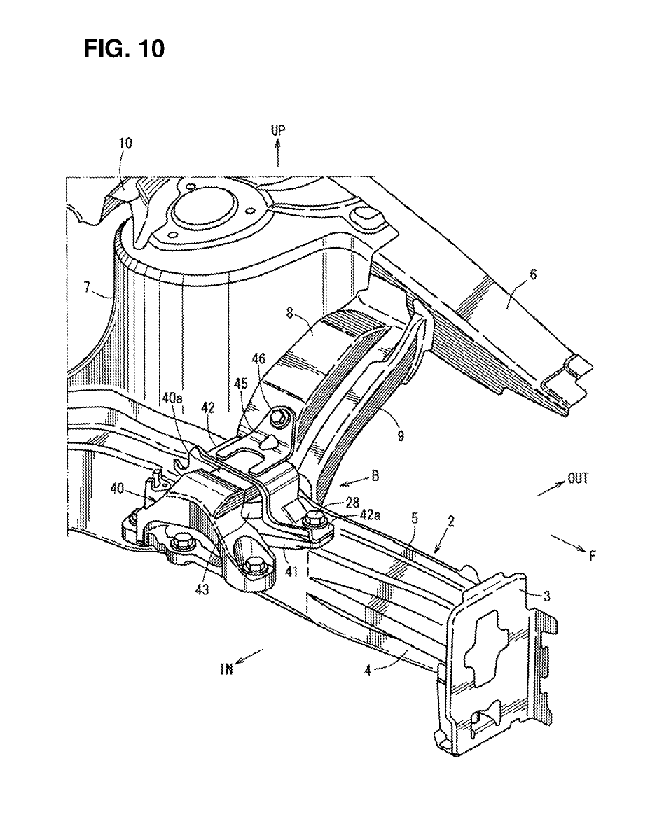

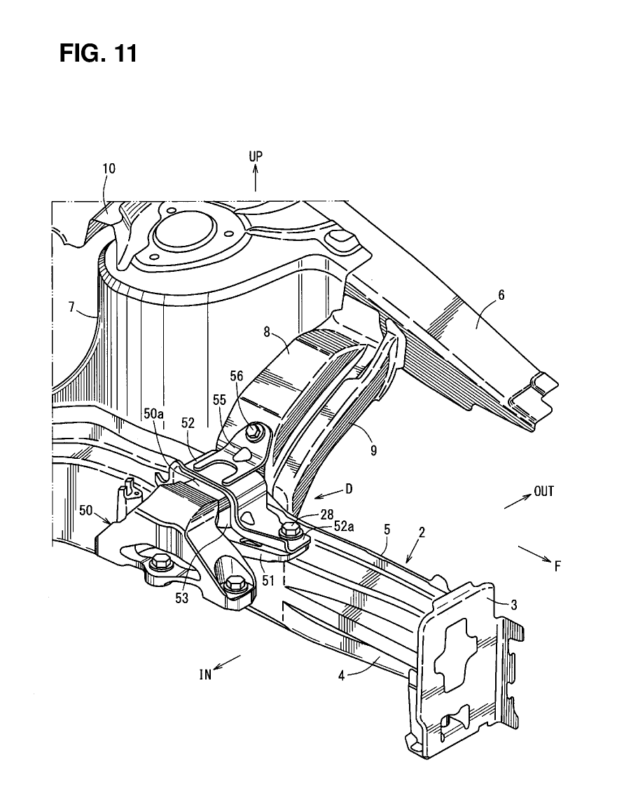

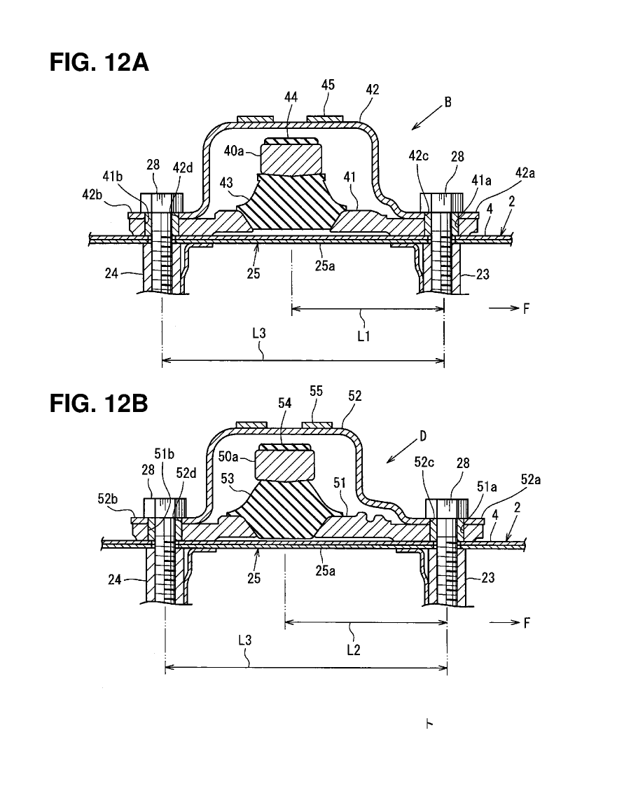

FIG. 10 is a perspective view showing a structure of a left-side powertrain mount of FIG. 1, FIG. 11 is a perspective view showing a structure of a left-side powertrain mount of FIG. 1, FIG. 12A is a major-part vertical sectional view of the structure of the powertrain mount of FIG. 10, and FIG. 12B is a major-part vertical sectional view of the structure of the powertrain mount of FIG. 11.

As shown in FIGS. 1, 10 and 12A, the transmission-side mount support portion B for the powertrain 13 comprises a transmission-side mount bracket 40, a die-cast-made lower bracket 41 and a sheet-metal-made upper bracket 42 which are vehicle-body-side mount brackets, and mount rubbers 43, 44. The lower bracket 41 is configured to extend in the vehicle longitudinal direction along an upper face of the front side frame inner 4, and attaching holes 41a, 41b for the bolts 28, 28 are formed at front-and-left both sides of the lower bracket 41.

The upper bracket 42 is configured in a hat shape, when viewed in the vehicle width direction, and attaching holes 42a, 42b for the bolts 28, 28 are formed at front-and-left both sides of the upper bracket 42.

The transmission-side mount bracket 40 includes an extension portion 40a which extends toward the front side frame 2, and the mount rubber 43 is provided between this extension portion 40a and the lower bracket 41 and the mount rubber 44 is provided at an upper portion of the extension portion 40a.

Herein, a longitudinal distance L3 between the respective axial center portions of the front-and-rear attaching holes 41a, 41b and a longitudinal distance L3 between the respective axial center portions of the front-and-rear attaching holes 42c, 42d are set to be the same as (equal to) the longitudinal distance L3 between the respective axial center portions of the nut members 23, 24 shown in FIG. 5, and a distance between each axial center portion of the front-side attaching holes 41a, 42c and the central portion, in the longitudinal direction, of the mount rubber 43 is set as L1. Further, the longitudinal distance L3 between the front-and-rear attaching points of the lower bracket 41 and the upper bracket 42 is set to be longer than the longitudinal length of the mount rubber 43.

The lower bracket 41 and the upper bracket 42 are fixed to the upper face portion of the front side frame inner 4 by using a pair of front-and-rear bolts 28, 28 and nut members 23, 24. Further, the upper bracket 42 is fixed to the wheel apron 8 by using a support piece 45 and a bolt 46 (see FIG. 10).

As shown in FIGS. 2, 11, and 12B, the transmission-side mount support portion D for the powertrain 16 comprises a transmission-side mount bracket 50, a die-cast-made lower bracket 51 and a sheet-plate-made upper bracket 52 which are vehicle-body-side mount brackets, and mount rubbers 53, 54.

The lower bracket 51 is configured to extend in the vehicle longitudinal direction along an upper face of the front side frame inner 4, and attaching holes 51a, 51b for the bolts 28, 28 are formed at its front-and-rear both-side portions.

The upper bracket 52 is configured in a hat shape, when viewed in the vehicle width direction, and attaching holes 52c, 52d for the bolts 28, 28 are formed at front-and-rear attaching seats 52a, 52b. The transmission-side mount bracket 50 includes an extension portion 50a which extends toward the font side frame 2, the mount rubber 53 is provided between the extension portion 50a and the lower bracket 51, and the mount rubber 54 is provided at an upper portion of the extension portion 50a.

Herein, a longitudinal distance L3 of respective axial center portions of the front-and-rear attaching holes 51a, 51b and a longitudinal distance L3 of respective axial center portions of the front-and-rear attaching holes 52c, 52d are set to be the same as (equal to) the longitudinal distance L3 of the respective axial center portions of the nut members 23, 24 shown in FIG. 5, and a distance between each of the axial center portions of the front-side attaching holes 51a, 52c and a central portion, in the longitudinal direction, of the mount rubber 53 is set as L2.

The distance L2 shown in FIG. 12B is set to be longer than the distance L1 shown in FIG. 12A. That is, a relational expression L2>L1 is established. Further, the longitudinal distance L3 between the front-and-rear attaching points of the lower bracket 51 is set to be longer than a longitudinal length of the mount rubber 53, and the longitudinal positions of the mount rubbers 43, 44, 53, 54 are configured to be changeable in a range between the longitudinal distance L3, i.e., at a position shown in FIG. 12A and a position shown in FIG. 12B.

That is, the mount support portions B, C, particularly, the mount rubbers 43, 53 which are held by the mount brackets 41, 51 are configured such that the longitudinal length thereof is changeable by exchanging the vehicle-body-side mount support portions B, C for each of the powertrains 13, 16. As shown in FIG. 12B, the above-described lower bracket 51 and upper bracket 52 are fixed to the upper face portion of the front side frame inner 4 by using a pair of front-and-rear bolts 28, 28 and nut members 23, 24. Further, the upper bracket 52 is fixed to the wheel apron 8 by using a support piece 55 and a bolt 56 (see FIG. 11).

As shown in FIG. 5, each of the front side frames 2 is configured to break at a frame breaking point X2 in the vehicle frontal collision, and the frame breaking point X2 of the transmission-side front side frame shown in the same figure is positioned right in front of the mount support portions B, D (the vehicle-body-side mount brackets 41, 42, 51, 52).

In comparison of the engine-side mount support portions A, C shown in FIGS. 9A, B with the transmission-side mount support portions B, D shown in FIGS. 12A, B, a rigidity of the vehicle-body-side mount brackets 31, 35 fixed to the engine-side front side frame 2 is set to be lower than that of the mount brackets 41, 42, 51, 52 fixed to the transmission-side front side frame 2 such that the mount brackets 31, 35 are made to break at a narrow portion 31a3 shown in FIG. 14 by a frame-breaking load which is generated in the vehicle frontal collision.

Further, the longitudinal distance L6 between the attaching points of the vehicle-side mount brackets 31, 35 fixed to the engine-side front side frame 2 shown in FIGS. 9A, B is set to be longer than the longitudinal length L3 between the attaching holes of the mount brackets 41, 42, 51, 52 fixed to the transmission-side front side frame 2 shown in FIG. 12A, B. That is, a relational expression L6>L3 is established.

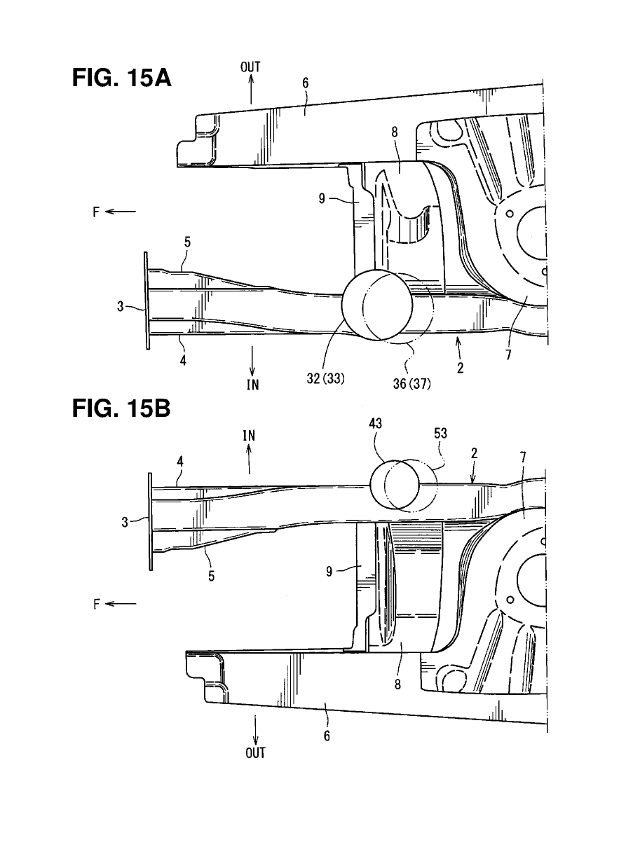

That is, as descried above, in a case where the plural powertrains 13, 16 having the different longitudinal positions of the gravity center are selectively installed to the common vehicle body, the mount support portions A, B are used for installing the powertrain 13 shown in FIG. 1 so that the positions of the mount rubbers 32, 33, 43 shown in FIG. 15 can be secured. Meanwhile, when the powertrain 16 shown in FIG. 2 is installed, the mount support portions C, D are used, so that the positions of the mount rubbers 36, 37, 53 shown in FIG. 15 can be secured. In particular, the longitudinal positions of the mount rubbers 32, 33, 43, 36, 37, 53 can be changed by exchanging the mount brackets, and thereby the positions of the resilient roll axes Y1, Y2 (see FIGS. 1 and 2) relative to the gravity center positions of the powertrains 13, 16 are configured to be changeable. Herein, in the figures, an arrow F shows a vehicle forward side, an arrow R shows a vehicle rearward side, an arrow IN shows an inward side in the vehicle width direction, an arrow OUT shows an outward side in the vehicle width direction, and an arrow UP shows a vehicle upward side.

As described above, the present embodiment is the powertrain mount structure of the vehicle which comprises a pair of right-and-left front side frames 2 extending in the vehicle longitudinal direction on the right-and-left both sides of the engine room 1 and the mount support portions A, B, C, D for mounting (attaching) the powertrains 13, 16 to the right-and-left front side frames 2, the mount support portions A-D comprising the mount rubbers 33, 37, 43, 53 and the mount brackets 31, 35, 41, 42, 51, 52, wherein the respective longitudinal distances (see the longitudinal distances L6, L3) between the front-and-rear attaching points of the right-and-left vehicle-body-side mount brackets 31, 35, 41, 42, 51, 52 are longer than the longitudinal lengths of the right-and-left mount rubbers 33, 37, 43, 53, and the longitudinal positions of the mount rubbers 33, 37, 43, 53 are changeable in a range between the front-and-rear attaching points of the right-and-left vehicle-body-side mount brackets 31, 35, 41, 42, 51, 52 (see FIGS. 1, 2, 9, 12 and 15).

According to the present structure, since the vehicle-body-side mount brackets 31, 35, 41, 42, 51, 52 in which the longitudinal distance (the front-and-rear distances L6, L3) between the front-and-rear attaching points of each of these mount brackets 31, 35, 41, 42, 51, 52 is longer than the longitudinal length of each of the mount rubbers 33, 37, 43, 53 are provided and the longitudinal position of each of these mount rubbers 33, 37, 43, 53 is changeable in a range between the front-and-rear attaching points of each of the vehicle-body-side mount brackets 31, 35, 41, 42, 51, 52, the positions of the resilient roll axes Y1, Y2 of the powertrains 13, 16 are configured to be changeable without decreasing the vehicle-body rigidity (the rigidity of the front side frame).

In the embodiment of the present invention, the vehicle is configured to selectively install the plural powertrains 13, 16 having the different longitudinal positions of gravity center to the common vehicle body, and the longitudinal positions of the mount rubbers 33, 37, 43, 53 which are held by the vehicle-body-side mount brackets are configured to be changeable by exchanging the right-and-left vehicle-body-side mount brackets 31, 35, 41, 42, 51, 52 for the powertrains 13, 16 (see FIGS. 1, 2, 9, 12 and 15).

According to the present structure, since the longitudinal position of each of the mount rubbers 33, 37, 43, 53 can be changed by exchanging the right-and-left vehicle-body-side mount brackets 31, 35, 41, 42, 51, 52 in a case where the longitudinal positions of the gravity center of the powertrains 13, 16 selectively installed to the common vehicle body differs, the positions of the resilient roll axes Y1, Y2 of the powertrains 13, 16 relative to the positions of the gravity center of the powertrains 13, 16 can be changeable. In particular, since the longitudinal position of each of the right-and-left mount rubbers 33, 37, 43, 53 can be made changeable by means of the right-and-left vehicle-body-side mount brackets 31, 35, 41, 42, 51, 52, it can be prevented that the resilient roll axes Y1, Y2 of the powertrains 13, 16 are configured to slant in the vehicle plan view.

In the present embodiment, the powertrain 13 having the relatively forward-positioned gravity center is supported by the mount support portions A, B having the relatively forward-positioned mount rubbers 32, 33, 43, and the powertrain 16 having the relatively rearward-positioned gravity center is supported by the mount support portions C, D having the relatively rearward-positioned mount rubbers 36, 37, 53.

Herein, in a case where another powertrain having a position of its gravity center which is located between the gravity center of the powertrain 13 and the gravity center of the powertrain 16, if the gravity center position of this powertrain is located slightly in front of the gravity center of the powertrain 16, for example, this powertrain may be supported by the above-described mount support portions C and B.

In the present embodiment, the above-described powertrains 13, 16 comprise the engines 11, 14 and the transmissions 12, 15, the above-described front side frame 2 is configured to break at the frame breaking points X1, X2 in the vehicle frontal collision, the frame breaking points X1, X2 are configured such that the frame breaking point X2 of the front side frame 2 located on the side of the transmissions 12, 15 is positioned in front of the above-described mount support portions B, D (the vehicle-body-side mount brackets 41, 42, 51, 52) and the frame breaking point X1 of the front side frame 2 located on the side of the engines 11, 14 is positioned between the attaching points of the above-described mount support portions A, C (the vehicle-body-side mount brackets 31, 35), the rigidity of the vehicle-body-side mount brackets 31, 35 of the mount support portions A, C provided on the side of the engines 11, 14 is set to be lower than that of the vehicle-body-side mount brackets 41, 42, 51, 52 of the mount support portions B, D provided on the side of the transmissions 12, 15 such that the mount brackets 31, 35 of the mount support portions A, C is made to break by the frame-breaking load, and the longitudinal distance (the longitudinal distance L6) between the attaching points of the vehicle-body-side mount brackets 31, 35 of the mount support portions A, C is set to be longer than that (the longitudinal distance L3) between the plural attaching points of the vehicle-body-side mount brackets 41, 42, 51, 52 of the mount support portions B, D (L6>L3) (see FIGS. 1, 2, 3, 5, 9 and 12).

According to this structure, since the vehicle-body-side mount brackets 31, 35 fixed to the front side frame 2 located on the engine side, which has the relatively-low vibration-input load, is made to break in accordance with the front side frame's breaking at the breaking point X1 of the front side frame 2 located on the engine side in the vehicle frontal collision and the longitudinal distance (the longitudinal distance L6) between the attaching points of the vehicle-body-side mount brackets 31, 35 fixed to the front side frame 2 located on the engine side is set to be longer than that (the longitudinal distance L3) between the attaching points of the vehicle-body-side mount brackets 41, 42, 51, 52 fixed to the front side frame 2 located on the transmission side, the degree of position changeability of the mount rubbers 32, 33, 36, 37 can be increased, without damaging the performance of absorbing front-collision energy which is attained by the breaking of the front side frame 2 located on the engine side in the vehicle frontal collision.

In the present embodiment, the vehicle-body-side mount brackets 42, 52 of the support portions B, D provided on the side of the transmission 12, 15 are made of the sheet metal member, and the vehicle-body-side mount brackets 31, 35 of the support portions A, C provided on the side of engines 11, 14 are made of the die-cast member (see FIGS. 9 and 12).

According to this structure, the transmission-side mount can bear a large load by means of the sheet-metal-made vehicle-body side mount brackets 42, 52 of the support portions B, D provided on the side of the transmission 12, 15. Meanwhile, since the vehicle-body-side mount brackets 31, 35 of the support portions A, C provided on the side of engines 11, 14 are made of the die-cast member, the engine-side mount can bear a small load in a normal state and also breaking of the front side frame 2 located on the side of the engines 11, 14 can be secured when the frame-breaking load is inputted in the vehicle frontal collision.

In the present embodiment, the reinforcing members (see the gussets 21, 25, 26) are provided inside the front side frames 2 at the positions between the front-and-rear attaching points of the vehicle-body-side mount brackets 31, 35, 41, 42, 51, 52, and the non-reinforcing-member arrangement portion a where no reinforcing member is arranged is provided at the specified position which corresponds to the frame breaking point X1 which is located between the attaching points of the vehicle-body-side mount brackets 31, 35 of the mount support portions A, C (see FIGS. 3 and 5).

According to this structure, since the non-reinforcing-member arrangement portion a where any reinforcing member (the gusset 21) is not provided between the attaching points of the vehicle-body-side mount brackets 31, 35 of the mount support portions A, C, it can be prevented that breaking of the front side frame 2 at the position located between the attaching points of the mount brackets 31, 35 in the vehicle frontal collision is blocked.

In correspondence of the present invention to the above-described embodiment, the first mount and the second mount of the present invention respectively correspond to the mount support portions A, C and the mount support portions B, D of the embodiment. Likewise, the first mount bracket and the second mount bracket respectively correspond to the mount brackets 31, 35 and the mount brackets 41, 42, 51, 52, the first mount rubber and the second mount rubber respectively correspond to the mount rubbers 33, 37 and the mount rubbers 43, 53, the longitudinal distances between the attaching points of the first and second mount bracket respectively correspond to the longitudinal distances L6, L3, the plural kinds of powertrain having different longitudinal positions of gravity center correspond to the powertrains 13, 16, one of the first and second mounts corresponds to the mount support portions B, D and the other of the first and second mounts corresponds to the mount support portions A, C (see claim 4), the frame breaking point corresponds to the points X1, X2, and the reinforcing member corresponds to the gussets 21, 25, 26. However, the present invention should to be limited to the above-described embodiment.

What is claimed is:

1. A powertrain mount structure of a vehicle comprising:
a pair of right-and-left front side frames extending in a vehicle longitudinal direction on right-and-left both sides of an engine room;
a first mount including a first mount rubber and a first mount bracket which holds the first mount rubber and has plural attaching points to one of the front side frames which are spaced apart from each other in the vehicle longitudinal direction, the first mount being configured to attach the powertrain to the one of the front side frames with the first mount bracket via the first mount rubber; and
a second mount including a second mount rubber and a second mount bracket which holds the second mount rubber and has plural attaching points to the other of the front side frames which are spaced apart from each other in the vehicle longitudinal direction, the second mount being configured to attach the powertrain to the other of the front side frames with the second mount bracket via the second mount rubber,
wherein each of said first and second mount brackets is configured such that a longitudinal distance between the plural attaching points to the front side frame is longer than a longitudinal length of the mount rubber, and
each of said first and second mount rubbers is configured such that a longitudinal position thereof is changeable in a range between the plural attaching points of each of said first and second mount brackets.

2. The lower vehicle-body structure of the automotive vehicle of claim 1, wherein the vehicle is configured to selectively install plural kinds of powertrain having different longitudinal positions of gravity center to a common vehicle body, said first and second mounts comprise plural kinds of mount which have the same longitudinal distance between the plural attaching points of the mount brackets and different longitudinal positions of the mount rubbers, and said changeable configuration of the longitudinal position of the mount rubbers is achieved by selecting one of said plural kinds of mount in accordance with the kind of powertrain selectively installed.

3. The lower vehicle-body structure of the automotive vehicle of claim 2, wherein said achieving of the changeable configuration of the longitudinal position of the mount rubbers by selecting one of the plural kinds of mount in accordance with the kind of powertrain selectively installed is configured such that in a case where the powertrain having a relatively forward-positioned gravity center is installed, the mount having a relatively forward-positioned mount rubber is selected.

4. The lower vehicle-body structure of the automotive vehicle of claim 1, wherein said powertrain comprises an engine and a transmission which are arranged in a vehicle width direction, said first and second mounts are configured such that one of the first and second mounts attaches the powertrain to the front side frame located on a transmission side and the other of the first and second mounts attaches the powertrain to the front side frame located on an engine side, each of said front side frames is configured to break at a frame breaking point in a vehicle frontal collision, said respective frame breaking points are configured such that the frame breaking point of the front side frame located on the transmission side is positioned in front of the mount bracket of said one of the first and second mounts and the frame breaking point of the front side frame located on the engine side is positioned between said attaching points of the mount bracket of said other of the first and second mounts, a rigidity of the mount bracket of said other of the first and second mounts is set to be lower than that of the mount bracket of said one of the first and second mounts such that the mount bracket of said other of the first and second mounts is made to break by a frame-breaking load which is generated in the vehicle frontal collision, and the longitudinal distance between the plural attaching points of the mount bracket of said other of the first and second mounts is set to be longer than that between the plural attaching points of the mount bracket of said one of the first and second mounts.

5. The lower vehicle-body structure of the automotive vehicle of claim 4, wherein said mount bracket of said one of the first and second mounts is made of a sheet metal member, and said mount bracket of said other of the first and second mounts is made of a die-cast member.

6. The lower vehicle-body structure of the automotive vehicle of claim 4, wherein reinforcing members are respectively provided inside the front side frames at positions between the plural attaching points of said vehicle-body-side mount brackets, and a non-reinforcing-member arrangement portion where no reinforcing member is arranged is provided at a specified position which corresponds to said frame breaking point of the front side frame located on the engine side which is located between the plural attaching points of said vehicle-body-side mount bracket.
